(19) United States
(12) Patent Application Publication
(10) Pub. No.: US 2008/0186645 A1
(43) Pub. Date: Aug. 7, 2008

(54) RELAY CONTROL APPARATUS

(75) Inventors: Mitsuaki MORIMOTO, Susono-shi (JP); Akinori MARUYAMA, Susono-shi (JP); Akiyoshi KANAZAWA, Susono-shi (JP); Takashi GO HARA, Susono-shi (JP)

Correspondence Address: SUGHRUE-265550, 2100 PENNSYLVANIA AVE. NW, WASHINGTON, DC, 20037-3213, US

(73) Assignee: YAZAKI CORPORATION, Tokyo (JP)

(21) Appl. No.: 11/947,959

(22) Filed: Nov. 30, 2007

(30) Foreign Application Priority Data
Feb. 6, 2007 (JP) 2007-026488

(51) Int. Cl. H01H 47/04

(52) U.S. Cl. 361/194

(57) ABSTRACT

A relay control apparatus includes a relay contact, a relay coil which turns on the relay contact when the relay coil is electrically conducted, and a current control unit which controls a first current and a second current. The first current is larger in a current amount per unit time than the second current. The current control unit controls to flow the first current through the relay coil until a predetermined time has elapsed from a beginning of an electrical conduction of the relay coil. The current control unit controls to start to flow the second current through the relay coil on or before the predetermined time has elapsed to maintain a turn-on state of the relay contact. The predetermined time is longer than a chattering time in which a chattering in the relay contact occurs at the beginning of the electrical conduction.

### BACKGROUND

The present invention is related to a relay control apparatus. More specifically, the present invention is directed to a relay control apparatus equipped with a relay coil which turns ON or OFF a relay contact when the relay coil is electrically conducted.

In a relay, when a relay coil is electrically conducted, a relay contact is turned ON, or OFF. Generally speaking, a relay coil mounted on an ECU (Engine Control Unit) of a vehicle, and the like has been continuously electrically conducted from an on-vehicle battery. As a result, more specifically, in a unit where a certain number of relays are mounted and are used under high temperature environment, heat generations of relay coils may cause a serious problem. Under such a circumstance, such a relay control apparatus has been proposed by which heat generations of relay coils themselves are suppressed by performing a PWM control operation for intermittently electrically conducting the relay coils (patent publication 1).

However, if the relay coils are electrically conducted under the above-described PWM control operation, then lengthy times are required from the beginning of the electrical conduction until relay contacts are switched from OFF states to ON states, or from ON states to OFF state. Accordingly, there is a problem that the relays cannot be firmly started.

Also, in the above-described conventional relay control apparatus, since the PWM control operations are carried out, the respective relays are required to employ such arrangements capable of providing PWM control outputs in a unit where a large number of the relays are mounted. As a result, plural sets of ICs having PWM output ports and PWM output functions are necessarily required, and a total number of these ICs are equal to that of these relays, which may cause a cost up problem.

Moreover, since the above-described conventional relay control apparatus performs the PWM control operations, there is another problem that the PWM control operations may constitute a noise generation source.

[patent publication 1] JP-A-2004-178967

[patent publication 2] JP-A-2005-261039

### SUMMARY

As a consequence, while considering the above-explained problems, the present invention has an object to provide a relay control apparatus capable of firmly starting a relay, and capable of suppressing a heat generation of a relay coil.

When the Inventors of the present invention have deeply investigated such a cause that a lengthy time is necessarily required since the electrical conduction of the relay is commenced until the relay contact is switched from the OFF state to the ON state, or the ON state to the OFF state, the Inventors could find out such a fact that a chattering (chattering phenomenon) occurs in which the relay contact is repeatedly turned ON/OFF in response to a beginning of electrically conducting of the relay coil. Then, the Inventors could find out that when the relay coil is electrically conducted by such a small current as a PWM control current, force exerted to the relay contact is weakened, and thus, the occurrence time of the above-described chattering is prolonged. Accordingly, the Inventors could accomplish the present invention based upon the above-described fact.

That is to say, in order to achieve the above object, according to the invention, there is provided a relay control apparatus, comprising:

a relay contact;

a relay coil which turns on the relay contact when the relay coil is electrically conducted; and

a current control unit which controls a first current and a second current,

wherein the first current is larger in a current amount per unit time than the second current;

wherein the current control unit controls to flow the first current through the relay coil until a predetermined time has elapsed from a beginning of an electrical conduction of the relay coil;

wherein the current control unit controls to start to flow the second current through the relay coil on or before the predetermined time has elapsed to maintain a turn-on state of the relay contact; and

wherein the predetermined time is longer than a chattering time in which a chattering in the relay contact occurs at the beginning of the electrical conduction.

In accordance with the configuration, the current control unit switches the current of electrically conducting of the relay coil in such a manner that the relay coil is electrically conducted by the large current including the first current from the beginning of electrically conducting of the relay coil until the predetermined time has elapsed, and thereafter, the relay coil is electrically conducted by the small current including the second current. As a consequence, the relay coil is electrically conducted by the large current from the beginning of the electrical conduction until the predetermined time has passed, so that the chattering occurrence time of the relay contact can be shortened. Thereafter, the relay coil can be electrically conducted by the small current by which the heat generation amount is small.

Preferably, the second current is a pulse current.

Also preferably, the current control unit includes a first switching unit which is connected to the relay coil in serial and is arranged between a power source and a ground, a second switching unit which is connected to the relay coil in serial and is arranged between the power source and a ground, a first switching control unit which turns on the first switching unit continuously so as to flow the first current until the predetermined time has elapsed, and a second switching control unit which turns on the second switching unit intermittently so as to start to flow the second current on or before the predetermined time has elapsed. The first switching unit is connected to the second switching unit in parallel.

In accordance with the configurations, when the first switching control unit continuously turns ON the first switching unit from the beginning of electrically conducting of the relay coil until the predetermined time has elapsed, the relay coil is continuously electrically conducted by the power source. When the second switching control unit intermittently turns ON the second switching unit on or before the predetermined time has elapsed, the relay coil is intermittently electrically conducted by the power source. As a consequence, the relay coil is electrically conducted by such a large current including the first current whose averaged electrical conduction amount (that is, current amount per unit time) is large from the beginning of the electrical conduction until the predetermined time has passed, so that the chattering occurrence time of the relay coil can be shortened. Thereafter, the relay coil can be electrically conducted by such a small current including the second current whose heat generation amount is small, namely, whose averaged electrically conducting amount is small.

Preferably, a plurality of the second switching units is provided so as to correspond to a plurality of the relay coils. The second switching control unit includes a pulse signal output unit which outputs a pulse signal for turning on the second switching units intermittently, a timing signal output unit which outputs timing signals for controlling a timing of turning on the second switching units intermittently, a distribution unit which distributes the pulse signal output from the pulse signal output unit to the second switching units, and a pulse signal supplying unit which supplies the distributed pulse signals to the second switching units while the timing signal is output.

In accordance with the configuration, in the second switching control unit, the pulse signal output unit outputs the pulse signal; the timing signal output unit outputs the timing signal; the distributing unit distributes the pulse signal output from the pulse signal output unit to the plurality of second switching units; and the plurality of pulse signal supplying units supplies the distributed pulse signals to the second switching units when the timing signal is output. As a consequence, since the pulse signals are distributed, the pulse signal output unit is no longer required with respect to each of the relay coils.

Preferably, the current control unit includes a first switching unit which is connected to the relay coil in serial and is arranged between a power source and a ground, a second switching unit which is connected to the relay coil in serial and is arranged between the power source and a ground, a resistor connected to the second switching unit in serial, a first switching control unit which turns on the first switching unit so as to flow the first current until the predetermined time has elapsed, and a second switching control unit which turns on the second switching unit so as to start to flow the second current on or before the predetermined time has elapsed. The first switching unit is connected to the second switching unit in parallel.

In accordance with the configuration, when the first switching unit turns ON the first switching unit from the beginning of electrically conducting of the relay coil until the predetermined time has elapsed, the relay coil is electrically conducted by the power source. When the second switching control unit turns ON the second switching unit on or before the predetermined time has elapsed, the relay coil is electrically conducted by such a current which is suppressed based upon the inserted resistor. As a consequence, the current control unit can switch the electrical conduction modes in such a manner that after the relay coil is electrically conducted by the large current including the first current from the beginning of the electrical conduction until the predetermined time has elapsed, the relay coil is electrically conducted by the small current including the second current without performing the PWM control operation.

Preferably, the current control unit includes a first switching unit which is connected to the relay coil in serial and is arranged between a first power source and a ground, a second switching unit which is connected to the relay coil in serial and is arranged between a second power source and a ground, a first switching control unit which turns on the first switching unit so as to flow the first current until the predetermined time has elapsed, and a second switching control unit which turns on the second switching unit so as to start to flow the second current on or before the predetermined time has elapsed. The second power source supplies lower power than the first power source.

In accordance with the configuration, when the first switching control unit turns ON the first switching unit from the beginning of electrically conducting of the relay coil until the predetermined time has elapsed, the relay coil is electrically conducted by the first power source capable of supplying the higher electric power. When the second switching control unit turns ON the second switching unit on or before the predetermined time has elapsed, the relay coil is electrically conducted by the second power source capable of supplying the lower electric power. As a consequence, the current control unit can switch the electrical conduction modes in such a manner that after the relay coil is electrically conducted by the large current including the first current from the beginning of the electrical conduction until the predetermined time has elapsed, the relay coil is electrically conducted by the small current including the second current without performing the PWM control operation.

As previously described, in accordance with the invention, since the relay coil is electrically conducted by the large current from the beginning of the electrical conduction until the predetermined time has elapsed, the chattering occurrence time of the relay contact can be reduced. Thereafter, the relay coil can be electrically conducted by the small current whose heat generation amount is small, so that the relay can be firmly started while suppressing the heat generation of the relay coil. Also, since the power consumption and the heat generation amount can be suppressed, the load given to the environment can be reduced.

In accordance with the invention, the relay coil is electrically conducted by such a large current whose averaged current amount is large from the beginning of the electrical conduction until the predetermined time has passed, so that the chattering occurrence time of the relay coil can be shortened. Thereafter, the relay coil can be electrically conducted by such a small current whose heat generation amount is small, namely, whose averaged current amount is small, so that the relay can be firmly started while the heat generation of the relay coil can be suppressed.

In accordance with the invention, since the pulse signal is distributed, the pulse signal output unit is no longer provided every relay coil, so that the cost down aspect can be improved.

In accordance with the invention, after the relay coil is electrically conducted by the large current from the beginning of the electrical conduction until the predetermined time has elapsed, the relay coil is electrically conducted by the small current without performing the PWM control operation. As a result, the relay can be firmly started while suppressing the heat generation from the relay coil and the relay does not constitute the generation source of the noise.

### BRIEF DESCRIPTION OF THE DRAWINGS

The above objects and advantages of the present invention will become more apparent by describing in detail preferred exemplary embodiments thereof with reference to the accompanying drawings, wherein like reference numerals designate like or corresponding parts throughout the several views, and wherein:

FIG. 1 is a circuit diagram for showing a switching apparatus into which a relay control apparatus according to a first embodiment of the present invention is assembled;

FIG. 2 is a block diagram for representing an arrangement of a PWM signal distributor which constitutes the relay control apparatus shown in FIG. 1;

FIG. 3 is a circuit diagram for representing an arrangement of the PWM signal distributor which constitutes the relay control apparatus shown in FIG. 1;

FIG. 4 is a time chart for showing signals output from a control unit and ON/OFF statuses of a first and a second transistors and a relay;

FIG. 5 is a circuit diagram for showing an arrangement of a switching apparatus according to another embodiment of the present invention;

FIG. 6 is a time chart for showing a PWM signal and a current flowing through a relay coil;

FIG. 7 is a circuit diagram for showing a switching apparatus into which a relay control apparatus according to a second embodiment of the present invention is assembled;

FIG. 8 is a time chart for showing ON/OFF statuses of a first and a second transistors and a relay; and

FIG. 9 is a circuit diagram for showing a switching apparatus into which a relay control apparatus according to a third embodiment of the present invention is assembled.

### DETAILED DESCRIPTION

### First Embodiment

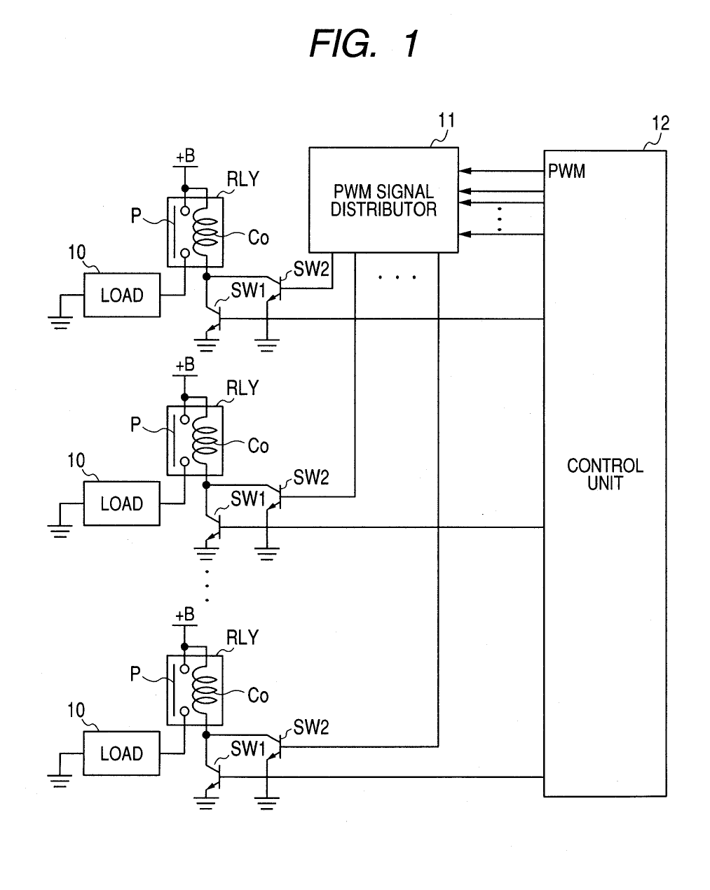

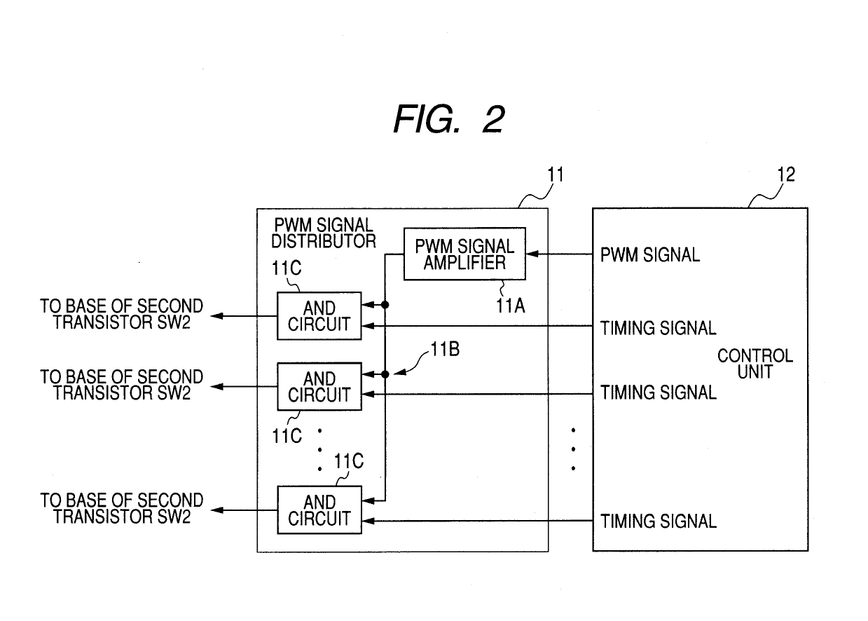

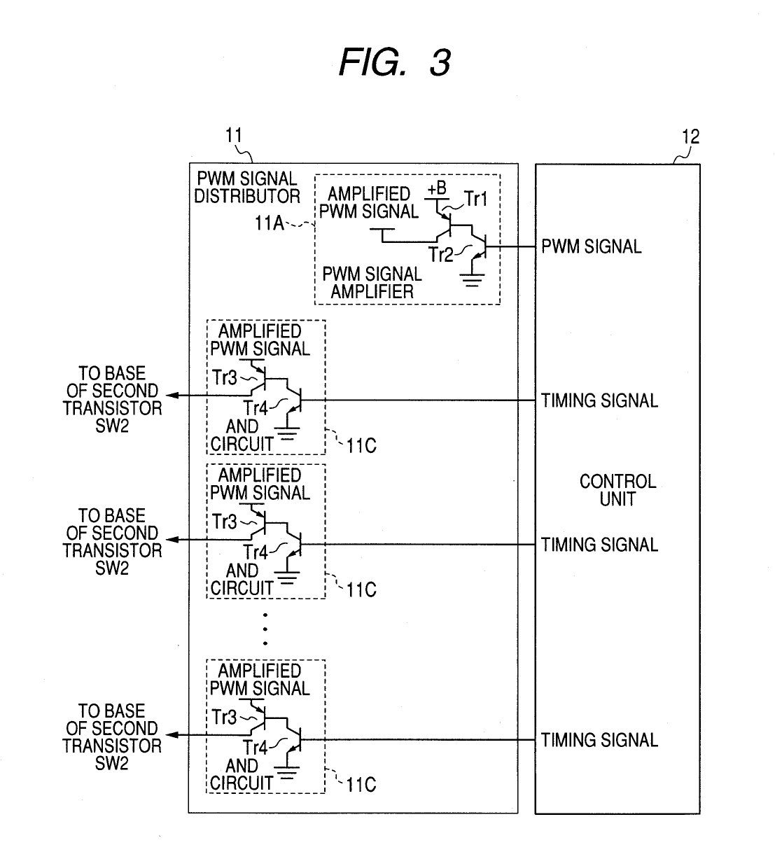

Referring now to drawings, a first embodiment of the present invention is described. FIG. 1 is a diagram for indicating a switching apparatus into which a relay control apparatus according to a first embodiment of the present invention is assembled. FIG. 2 is a block diagram for showing an arrangement of a PWM signal distributor which constitutes the relay control apparatus shown in FIG. 1. FIG. 3 is a circuit diagram for showing the arrangement of the PWM signal distributor which constitutes the relay control apparatus indicated in FIG. 1.

As indicated in the drawings, a plurality of relays “RLY” corresponding to a plurality of loads 10 are provided in the switching apparatus. Each of the relays “RLY” is constituted by a relay contact “P” and a relay coil “Co” which turns ON the relay contact P when the relay RLY is electrically conducted. The relay contact P is provided between an on-vehicle battery “B” and the loads 10.

As a result, when the relay contacts P are turned ON, electric power is supplied from the on-vehicle battery B to the loads 10. On the other hand, when the relay contacts P are turned OFF, the supplies of the electric power from the on-vehicle battery B to the loads 10 are cut out. The above-described relay coils Co are connected between the on-vehicle batteries B and the ground in a parallel manner with respect to the relay contacts P.

The switching apparatus includes first transistors “SW1” (first switching units), second transistors “SW2” (second switching units), a PWM signal distributor 11, and a control unit 12 such as a CPU (Central Processing Unit).

The first transistors SW1 and the second transistors SW2 are connected parallel to each other. The first and second transistors SW1 and SW2 are connected to the relay Co in serial and be provided between the on-vehicle battery B and the ground B. Each base of the first transistors SW1 is connected to the control unit 12. Each base of the second transistors SW2 is connected via the PWM signal distributor 11 to the control unit 12.

As indicated in FIG. 2, the above-explained PWM signal distributor 11 includes a PWM signal amplifier 11A, a distributor 11B functioning as a distributing unit, and a plurality of AND circuits 11C functioning as a pulse signal supplying unit. The PWM signal amplifier 11A amplifies a PWM signal (pulse signal) output from the control unit 12. The PWM (pulse-width modulation) signal is a pulsed signal, and is supplied to the bases of the second transistors SW2 in order to intermittently turn ON the second transistors SW2.

The distributor 11B distributes the PWM signals with respect to the plurality of second transistors SW2. Each of the AND circuits 11C is provided between the distributor 11B and the base of the second transistor SW2. The AND circuits 11C correspond to such circuits that when timing signals are supplied thereto from the control unit 12, the AND circuits 11C supply the distributed PWM signals to the bases of the second transistor SW2. The timing signals correspond to such signals for instructing time periods during which the second transistors SW2 are intermittently turned ON, namely, for instructing time periods during which PWM control operations are performed.

As indicated in FIG. 3, the above-explained PWM signal amplifier 11A is arranged by a PNP type transistor Tr1 and an NPN transistor Tr2. An emitter of the transistor Tr1 is connected to the on-vehicle battery B, and a collector thereof constitutes an output terminal. A collector of the transistor Tr2 is connected to a base of the transistor Trn, and an emitter of this transistor Tr2 is connected to the ground. The PWM signal is supplied from the control unit 12 to a base of the transistor Tr2.

In accordance with the above-described arrangement, both the transistors Tr1 and Tr2 are turned ON every time the level of the PWM signal becomes an H level. As a result, a pulsed battery voltage V_{B} (namely, supply voltage of the on-vehicle battery B) is output as amplified PWM signal from the collector of the transistor Tr1, which corresponds to the output terminal.

As represented in FIG. 2, the amplified PWM signal is distributed to the respective AND circuits 11C by the distributor 11B. As represented in FIG. 3, each of the AND circuits 11C is configured by a PNP type transistor Tr3 and an NPN type transistor Tr4. The amplified PWM signal is supplied to an emitter of the transistor Tr3, and a collector of this transistor Tr3 is connected to the base of the second transistor SW2. A collector of the transistor Tr4 is connected to the base of the transistor Tr3, and an emitter of the transistor Tr4 is connected to the ground. A timing signal is supplied from the control unit 12 to the base of the transistor Tr3.

In accordance with the above-described arrangement, while such a timing signal having an H level is output, both the transistors Tr3 and Tr4 are turned ON. In response to the turn-ON status, an amplified PWM signal is output from the collector of the transistor Tr3. Then, the PWM signal is supplied to the base of the second transistor SW2, so that the second transistor SW2 is intermittently turned ON. To the contrary, while the timing signal is not output, the transistors Tr3 and Tr4 are turned OFF, so that the output of the PWM signal from the collector of the transistor Tr3 is stopped.

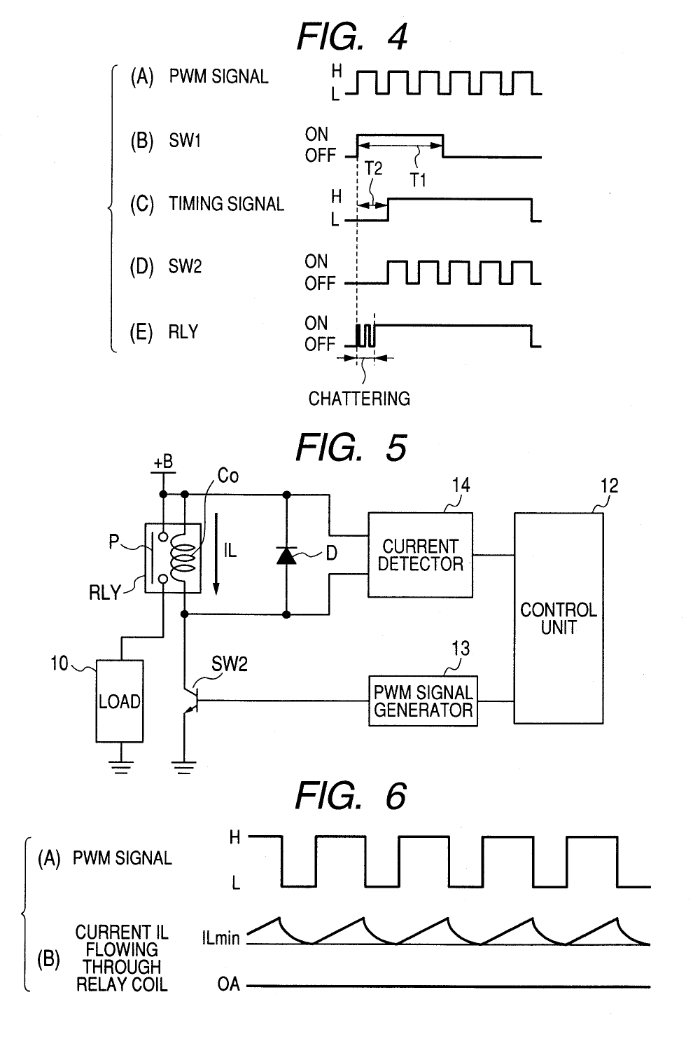

Referring now to a time chart shown in FIG. 4, a description is made of operations of the switching apparatus with employment of the above-described arrangement. In FIG. 4, (A) is a time chart for showing a PWM signal output from the control unit 12; (B) is a time chart for indicating ON/OFF statuses of the first transistor SW1; (C) is a time chart for representing a timing signal output from the control unit 12; (D) is a time chart for showing ON/OFF statuses of the second transistor SW2; and (E) is a time chart for showing ON/OFF statuses of the relay RLY.

Firstly, the control unit 12 is operated as a pulse signal output unit, and thus, outputs such a PWM signal as shown in FIG. 4. The PWM signal is amplified by the PWM signal amplifier 11A provided in the PWM signal distributor 11, and thereafter, the amplified PWM signals are supplied to the respective AND circuits 11C by the distributor 11B. Each of the AND circuits 11C does not supply the PWM signal to the base of the second transistor SW2 while the timing signal is not output from the control unit 12, so that the second transistor SW2 is brought into an OFF status.

Next, the control unit 12 is operated as a first switching control unit, and thus, continuously turns ON the first transistor SW1 corresponding to such a relay RLY which is wanted to be driven from an OFF status to an ON status (refer to FIG. 4). When the first transistor SW1 is turned ON, the relay coil Co is continuously electrically conducted by receiving the electric power from the on-vehicle battery B. When the relay coil Co is electrically conducted, the relay contact P is completely switched from the OFF status to the ON status after chattering occurs which repeats ON/OFF statuses (refer to FIG. 4).

Next, after a constant time “T2” elapses since the first transistor SW1 is turned ON, the control unit 12 outputs a timing signal to the AND circuit 11C corresponding to such a relay RLY to be driven from the OFF status to the ON status (refer to FIG. 4). The AND circuit 11C supplies the PWM signal to the base of the second transistor SW2 in response to the output operation of the above-described timing signal. As a result, the second transistor SW2 is intermittently turned ON/OFF. As a time instant when the above-described timing signal is output, since the ON status of the first transistor SW1 is continued, the relay coil Co is continuously electrically conducted.

Thereafter, when the control unit 12 turns ON the first transistor SW1 and then a predetermined time “T1” elapses, the control unit 12 turns OFF the first transistor SW1. It should be noted that the above-described predetermined time T1 is set to a time which is longer than the occurrence time of the chattering, and furthermore, a time which is longer than the time during which turning ON/OFF operation of the second transistor SW2 becomes stable.

When the first transistor SW1 is turned OFF and the second transistor SW2 is brought into such a condition that the second transistor SW2 is intermittently turned ON, the relay coil Co is intermittently electrically conducted. As described above, since the relay coil Co is intermittently electrically conducted, the electrically conducting amount can be suppressed by the duty ratio of the PWM signal, as compared with the electrically conducting amount when the relay coil Co is continuously electrically conducted. It should also be understood that the control unit 12 outputs a PWM signal having such a frequency and such a duty ratio by which even when the relay coil Co is intermittently electrically conducted, the relay contact P is not turned OFF.

Thereafter, the control unit 12 stops the supply of the timing signal. In response to stopping of the supply of this timing signal, the AND circuit 11C stops the supply of the PWM signal to the base of the second transistor SW2. In response to stopping of the supply of the PWM signal, the second transistor SW2 is brought into an OFF status, so that the electrical conduction to the relay coil Co is stopped, and the relay contact P is switched OFF.

As apparent from the above description, the first transistors SW1, the second transistors SW2, the PWM signal distributor 11, and the control unit 12 constitute a current control unit. Also, the PWM signal distributor 22 and the control unit 12 constitute a second switching control unit.

In accordance with the above-described switching apparatus, when the control unit 12 continuously turns ON the first transistor SW1 from the beginning of the electrical conduction with respect to the relay coil Co until the predetermined time T1 has elapsed, the relay coil Co is continuously electrically conducted by the on-vehicle battery B. When the control unit 12 intermittently turns ON the second transistor SW2 on which the predetermined time T1 has elapsed, the relay coil Co is intermittently electrically conducted by the on-vehicle battery B. As a consequence, the relay coil Co is electrically conducted by such a large current whose averaged electrical conduction amount is large from the beginning of the electrical conduction until the predetermined time T1 has passed, so that the chattering occurrence time of the relay coil Co can be shortened. Thereafter, the relay coil Co can be electrically conducted by such a small current whose heat generation amount is small, namely, whose averaged electrically conducting amount is small, so that the relay RLY can be firmly started while the heat generation of the relay coil Co can be suppressed. Also, in accordance with the above-described switching apparatus, since both the power consumption and the heat generation amount can be suppressed, the load thereof given to the environment can be reduced.

Further, in accordance with the above-described switching apparatus, the control unit 12 outputs both the PWM signal and the timing signal, the distributor 11B distributes the PWM signal output from the control unit 12 to the plurality of AND circuits 11C, and the plurality of AND circuits 11C supply the distributed PWM signals to the second transistors SW2 when the timing signals are output. As a consequence, since the PWM signals are distributed, there is no necessity to provide such an IC having a PWM output port and a PWM output function with respect to each of the relay coils Co, so that the cost-down aspect of the switching apparatus can be improved.

It should also be noted that in the above-described first embodiment, although the control unit 12 outputs the PWM signal whose duty ratio is previously determined, the present invention is not limited only to this example. For example, in the case that the load 10 is an inductor, as shown in FIG. 5, a regenerative diode D is required. As indicated in FIG. 6, due to the operation of this regenerative diode D, a current “IL” flows through the relay coil Co even in a time duration when the level of the PWM signal is “L (low).” It should also be noted that in FIG. 5, reference numeral 13 indicates a PWM signal generator, and the control unit 12 can control a duty ratio of a PWM signal generated by the PWM signal generator 13.

As a consequence, the following idea may be conceived. That is, a current detector 14 may monitor the current IL flowing through the relay coil Co, and the control unit 12 may output a PWM signal having a duty ratio determined in response to the current IL flowing through the relay coil Co. Since such a current IL flowing in a time period during which the PWM signal is the “L” level constitutes a minimum current “ILmin” which flows through the relay coil Co during the PWM operation thereof, if the duty ratio is controlled in such a manner that the current IL is approximately equal to a minimum holding current of the relay RLY, then power consumption of the relay coil Co while the relay RLY is driven may be reduced to minimum power consumption. The above-described minimum holding current implies a minimum value of such a current which is required in order that the relay contact P maintains the ON status after the chattering of the relay contact P is accomplished.

Also, in the above-described first embodiment, the plurality of relays RLY are provided. However, the present invention is not limited only to this example, but may be modified. That is, only one relay RLY may be alternatively employed.

Also, in the above-described first embodiment, although one PWM signal output from the control unit 12 is distributed to the plurality of second transistors SW2, the present invention is not limited only thereto. Alternatively, for example, the control unit 12 may output a plurality of PWM signals in correspondence with a total number of these second transistors SW2.

Also, in the above-explained first embodiment, although the PWM signal amplifier 11A is provided in the PWM signal distributor 11, the present invention is not limited thereto. Alternatively, if the second transistors SW2 may be turned ON/OFF in response to PWM signals output from the control unit 12, then the above-described PWM signal amplifier 11A may not be provided.

Also, in the above-described first embodiment, after the constant time T2 has elapsed from which the first transistor SW1 is turned ON, the PWM control operation for intermittently turning ON the second transistor SW2 is commenced. The present invention is not limited only to this example. Alternatively, the PWM control operation of the second transistor SW2 may be carried out at the time when the predetermined time T1 has elapsed. As a consequence, for instant, when the predetermined time T1 has elapsed from which the first transistor SW1 is turned ON, the PWM control operation for intermittently turning ON the second transistor SW2 may be commenced. Furthermore, the PWM control operation may be commenced at the same time when the first transistor SW1 is turned ON.

As indicated in FIG. 3, in the first embodiment, each of the AND circuits 11C is configured by the PNP type transistor Tr3 and the NPN type transistor Tr4. The present invention is not limited only to this example. Alternative to each of the AND circuits 11C, a circuit which outputs the PWM signal only when the timing signal is supplied may be employed.

### Second Embodiment

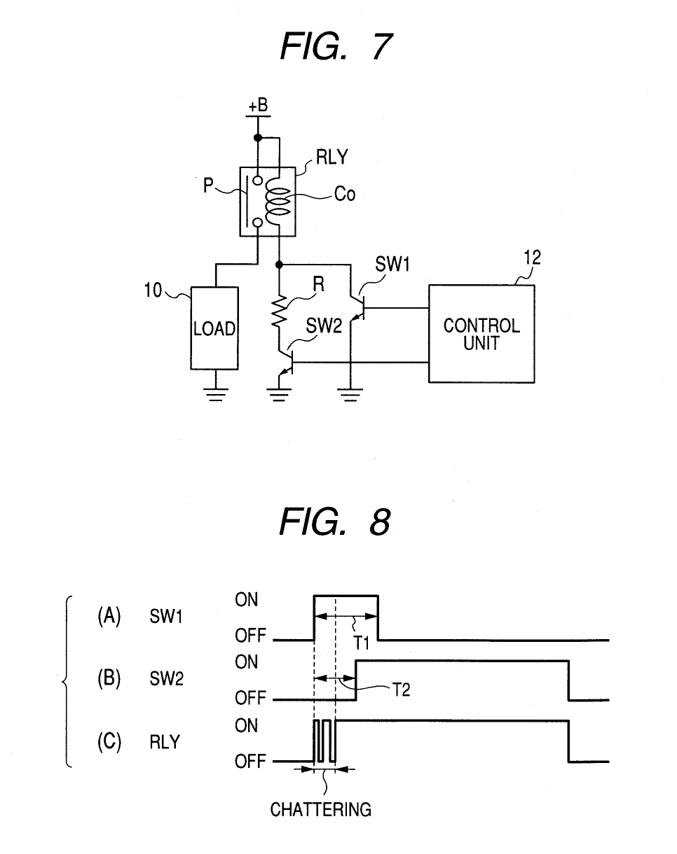

Next, a description is made of a second embodiment of the present invention referring to drawings. FIG. 7 is a circuit diagram for showing a switching control apparatus into which a relay control apparatus according to the second embodiment is assembled. It should be understood that the same reference numerals shown in the switching apparatus of FIG. 1 will be employed as those for denoting the same circuit elements indicated in FIG. 7, and therefore, detailed descriptions thereof will be omitted. As indicated in FIG. 1, although a plurality of relays RLY is provided in correspondence with a plurality of loads 10, only one relay RLY in FIG. 7 is shown for the sake of a simple illustration.

The switching apparatus includes a first transistor “SW1” (a first switching unit), a second transistor “SW2” (a second switching unit), a resistor R and a control unit 12 such as a CPU.

The first transistors SW1 and the second transistor SW2 are connected parallel to each other. The first and second transistor SW1 and SW2 are connected to the relay coils Co in serial and provided between the on-vehicle battery B and the ground. A base of the first transistor SW1 is connected to the control unit 12. A base of the second transistor SW2 is connected to the control unit 12. The resistor R is connected to the second transistor SW2 in serial.

Referring now to a time chart shown in FIG. 8, a description is made of operations of the switching apparatus with employment of the above-described arrangement. In FIG. 8, (A) is a time chart for indicating ON/OFF statuses of the first transistor SW1; (B) is a time chart for showing ON/OFF statuses of the second transistor SW2; and (C) is a time chart for showing ON/OFF statuses of the relay RLY.

Firstly, the control unit 12 turns ON the first transistor SW1 in response to a beginning of electrically conducting of the relay coil Co. When the first transistor SW1 is turned ON, the relay coil Co is electrically conducted by receiving electric power supplied from the on-vehicle battery B. At this time, a current having a magnitude determined in correspondence with a coil resistance flows through the relay coil Co. When the relay coil Co is electrically conducted, the relay contact P is completely switched from the OFF status to the ON status after a chattering occurs in which the relay contact P is repeatedly turned ON and OFF.

Next, after a constant time “T2” elapses from which the first transistor SW1 is turned ON, the control unit 12 turns ON the second transistor SW2. At this time, since the first transistor SW1 is also turned ON, a current having a magnitude determined in response to the coil resistance flows through the relay coil Co in a similar manner to the above-described current when only the first transistor SW 1 is turned ON.

Thereafter, when the control unit 12 turns ON the first transistor SW1 and then a predetermined time “T1” (> the constant time “T2”) elapses, the control unit 12 turns OFF the first transistor SW1. It should be noted that the above-described predetermined time T1 is set to a time which is longer than the occurrence time of the chattering of the relay RLY, and furthermore, a time which is longer than the time during which turning ON/OFF operation of the second transistor SW2 becomes stable.

When the first transistor SW1 is turned OFF and the second transistor SW2 is turned ON, such a current flows through the relay coil Co, the magnitude of which is determined in response to a resistance value calculated by adding the coil resistance and the resistor R. Since the synthesized resistor is increased by inserting the resistor R, the current flowing through the relay coil Co is suppressed. As a result, power consumption of the relay coil Co is reduced, so that a heat generation amount thereof is lowered. Even in the resistor R portion, since power consumption occurs, heat is generated from the resistor R portion. However, this resistor R portion is positionally separated from the relay coil Co, so that a peak temperature caused by heat concentration can be reduced.

It should also be noted that the resistance value of the resistor R is selected to be such a value by that a voltage applied to the relay coil Co does not become lower than, or equal to a minimum operating voltage thereof so as to firmly operate the relay RLY. Thereafter, when the control unit 12 turns OFF the second transistor SW2, the electrical conduction of the relay coil Co is stopped, so that the ON status of the relay contact P is switched to the OFF status.

As apparent from the above description, the first transistor SW1, the second transistor SW2, and the control unit 12 are operated as a current control unit. Also, the control unit 12 is operated as a first switching control unit, and a second switching control unit.

In accordance with the above-described switching control apparatus, when the control unit 12 turns ON the first transistor SW1 only for the predetermined time T1 in response to the beginning of the electrical conduction with respect to the relay coil Co, the relay coil Co is electrically conducted. When the control unit 12 turns ON the second transistor SW2 on which the predetermined time T1 has elapsed, the relay coil Co is electrically conducted by the current which is suppressed by the resistor R. As a consequence, while the PWM control operation is not performed, the electrically conducting mode of the relay coil Co can be switched in such a manner that the relay coil Co can be electrically conducted by the large current from the beginning of the electrical conduction until the predetermined time T1 has elapsed, and thereafter, can be electrically conducted by the small current. As a result, the relay RLY can be firmly started while the heat generation of the relay coil Co can be suppressed and the relay RLY does not constitute the noise generation source.

It should also be understood that in the second embodiment, after the constant time T2 has elapsed from which the first transistor SW1 is turned ON, the second transistor SW2 is turned ON. The present invention is not limited only to this example. The second transistor SW2 may be merely ON-state at the time when the predetermined time T1 has elapsed. As a consequence, for example, when the predetermined time T1 has passed from which the first transistor SW1 is turned ON, the second transistor SW2 may be turned ON, or both the first transistor SW1 may be turned ON and the second transistor SW2 may be turned ON.

### Third Embodiment

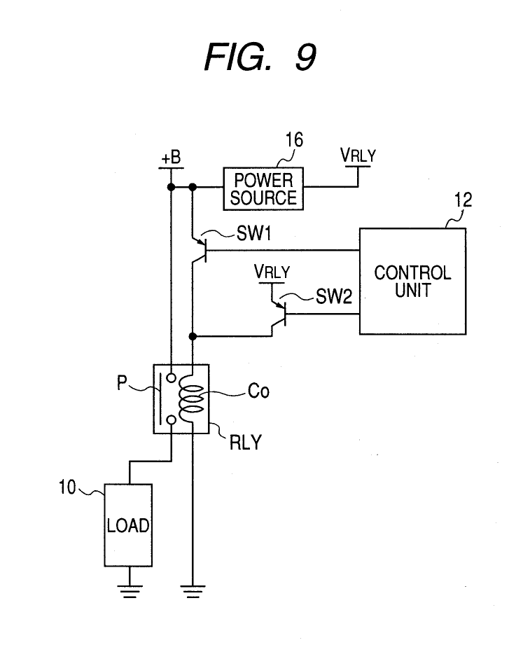

Next, a description is made of a third embodiment of the present invention. FIG. 9 is a circuit diagram for showing a switching control apparatus into which a relay control apparatus according to the third embodiment is assembled. It should be understood that the same reference numerals shown in the switching apparatus of FIG. 1 will be employed as those for denoting the same circuit elements indicated in FIG. 9, and therefore, detailed descriptions thereof will be omitted. As indicated in FIG. 1, although a plurality of relays RLY is provided in correspondence with a plurality of loads 10, only one relay RLY in FIG. 9 is shown for the sake of a simple illustration.

The switching apparatus includes a first transistor “SW1” (a first switching unit), a second transistor “SW2” (a second switching unit), a power source 16 (a second power source), and a control unit 12 such as a CPU. The power source 16 applies a relay voltage “V_{RLY}” which is lower than a battery voltage “V_{B}” of an on-vehicle battery B. The relay voltage V_{RLY} is set to be equal to a minimum holding voltage of the relay RLY. It should also be understood that the above-described minimum holding voltage implies such a minimum value of a voltage which is required that the relay contact P maintains an ON status after a chattering of the relay contact P is accomplished.

The first transistor SW1 is connected to the relay coil “Co” in serial and provided between the on-vehicle battery B and the ground. The second transistor SW2 is connected to the relay coil Co in serial and provided between the power source 16 and the ground.

A description is made of operations as to the switching apparatus with employment of the above-described circuit arrangement. Firstly, the control unit 12 turns ON the first transistor SW1 in response to a beginning of electrically conducting of the relay coil Co. When the first transistor SW1 is turned ON, the relay coil Co is electrically conducted by receiving electric power supplied from the ON-vehicle battery B. At this time, a current having a magnitude determined in correspondence with the battery voltage V_{B} flows through the relay coil Co. When the relay coil Co is electrically conducted, the relay contact P is completely switched from the OFF status to the ON status after a chattering occurs in which the relay contact P is repeatedly turned ON and OFF.

Next, after a predetermined time “T1” elapses from which the first transistor SW1 is turned ON, the control unit 12 turns ON the second transistor SW2, and also, turns OFF the first transistor SW1. It should also be noted that the predetermined time “T1” is set to be longer than the chattering occurrence time of the relay contact P.

When the first transistor SW1 is turned OFF and the second transistor SW2 is turned ON, a current having a magnitude determined in correspondence with a relay voltage “V_{RLY}” flows through the coil Co. The voltage applied between the both terminals of the relay coil Co is switched to the relay voltage V_{RLY} lower than the battery voltage V_{B} in the above-described manner, so that the current flowing through the relay coil Co may be suppressed. Thereafter, when the control unit 12 turns OFF the second transistor SW2, the electrical conduction of the relay coil Co is stopped, so that the relay contact P is switched from the ON status to the OFF status.

In such a case that a switching power source for lowering the battery voltage V_{B} is employed as the above-described power source 16, loss of power consumption is small, which may have a very large effect with respect to the reduction of the heat generation.

In accordance with the third embodiment, when the control unit 12 turns ON the first transistor SW1 only for the predetermined time T1 in response to the beginning of the electrical conduction with respect to the relay coil Co, the relay coil Co is electrically conducted by the on-vehicle battery B having the higher battery voltage V_{B}. When the control unit 12 turns ON the second transistor SW2 on which the predetermined time T1 has elapsed, the relay coil Co is electrically conducted by the power source 16 having the lower supply voltage. As a consequence, while the PWM control operation is not performed, the electrically conducting mode of the relay coil Co can be switched in such a manner that the relay coil Co can be electrically conducted by the large current from the beginning of the electrical conduction until the predetermined time T1 has elapsed, and thereafter, can be electrically conducted by the small current. As a result, the relay RLY can be firmly started while the heat generation of the relay coil Co can be suppressed and the relay RLY does not constitute the noise generation source.

It should also be understood that in the third embodiment, although the voltage sources are employed as the first power source and the second power source, the present invention is not limited only to this example. For example, a current source may be employed.

It should also be noted that in the above-described first to third embodiments, as the relay RLY, such a relay is employed that when the relay coil Co is electrically conducted, the relay contact P is turned ON. However, the present invention is not limited only to this example. For instance, as the relay RLY, such a relay is employed that when the relay coil Co is electrically conducted, the relay contact P is turned OFF.

While the above-described embodiments merely indicate the typical modes of the present invention, the present invention is not limited only to these embodiments. In other words, the present invention may be modified in various manners without departing from the gist of the presentation.

What is claimed is:

1. A relay control apparatus, comprising:
a relay contact;
a relay coil which turns on the relay contact when the relay coil is electrically conducted; and
a current control unit which controls a first current and a second current,
wherein the first current is larger in a current amount per unit time than the second current;
wherein the current control unit controls to flow the first current through the relay coil until a predetermined time has elapsed from a beginning of an electrical conduction of the relay coil;
wherein the current control unit controls to start to flow the second current through the relay coil on or before the predetermined time has elapsed to maintain a turn-on state of the relay contact; and
wherein the predetermined time is longer than a chattering time in which a chattering in the relay contact occurs at the beginning of the electrical conduction.

2. The relay control apparatus according to claim 1,
wherein the second current is a pulse current.

3. The relay control apparatus according to claim 1,
wherein the current control unit includes:
a first switching unit which is connected to the relay coil in serial and is arranged between a power source and a ground;
a second switching unit which is connected to the relay coil in serial and is arranged between the power source and a ground;
a first switching control unit which turns on the first switching unit continuously so as to flow the first current until the predetermined time has elapsed; and
a second switching control unit which turns on the second switching unit intermittently so as to start to flow the second current on or before the predetermined time has elapsed, and
wherein the first switching unit is connected to the second switching unit in parallel.

4. The relay control apparatus according to claim 3,
wherein a plurality of the second switching units is provided so as to correspond to a plurality of the relay coils; and
wherein the second switching control unit includes:
a pulse signal output unit which outputs a pulse signal for turning on the second switching units intermittently;
a timing signal output unit which outputs timing signals for controlling a timing of turning on the second switching units intermittently;
a distribution unit which distributes the pulse signal output from the pulse signal output unit to the second switching units; and
a pulse signal supplying unit which supplies the distributed pulse signals to the second switching units while the timing signal is output.

5. The relay control apparatus according to claim 1,
wherein the current control unit includes:
a first switching unit which is connected to the relay coil in serial and is arranged between a power source and a ground;
a second switching unit which is connected to the relay coil in serial and is arranged between the power source and a ground;
a resistor connected to the second switching unit in serial;
a first switching control unit which turns on the first switching unit so as to flow the first current until the predetermined time has elapsed; and
a second switching control unit which turns on the second switching unit so as to start to flow the second current on or before the predetermined time has elapsed, and
wherein the first switching unit is connected to the second switching unit in parallel.

6. The relay control apparatus according to claim 1,
wherein the current control unit includes:
a first switching unit which is connected to the relay coil in serial and is arranged between a first power source and a ground;
a second switching unit which is connected to the relay coil in serial and is arranged between a second power source and a ground;
a first switching control unit which turns on the first switching unit so as to flow the first current until the predetermined time has elapsed; and
a second switching control unit which turns on the second switching unit so as to start to flow the second current on or before the predetermined time has elapsed, and
wherein the second power source supplies lower power than the first power source.
